(19) United States
(12) Patent Application Publication
(10) Pub. No.: US 2026/0105767 A1
(43) Pub. Date: Apr. 16, 2026

(54) REMOTE VERIFICATION OF PHYSICAL DOCUMENTS

(71) Applicant: University of Florida Research Foundation, Incorporated, Gainesville, FL (US)

(72) Inventor: Juan Gilbert, Gainesville, FL (US)

(21) Appl. No.: 19/293,463

(22) Filed: Aug. 7, 2025

Related U.S. Application Data
(60) Provisional application No. 63/706,858, filed on Oct. 14, 2024.

(51) Int. Cl. G06V 30/14; G06V 30/19

(52) U.S. Cl. CPC G06V 30/1448; G06V 30/1916

(57) ABSTRACT

Various embodiments of the present disclosure provide methods, apparatus, systems, computing devices, computing entities, and/or the like for remotely verifying a physical document by receiving a remote document verification request indicating a subject document to be verified, transmitting an interface configured to receive user input corresponding to the subject document, receiving user input corresponding to the subject document, generating an updated document based on the subject document and the received user input, creating a physical document corresponding to the updated document, providing a media feed displaying the physical document as it is created, and causing transmission of a prompt to be displayed to the user via which the user can indicate verification of the physical document.

### CROSS-REFERENCES TO RELATED APPLICATION(S)

The present application claims priority to U.S. Patent Application No. 63/706,858 (filed on Oct. 14, 2025), which is incorporated by reference herein in its entirety.

### BACKGROUND

Various embodiments of the present disclosure address technical challenges related to generating and verifying physical documents from a remote location.

As the prevalence of digital document utilization is ever increasing, paper documents are still the preferred traditional evidence in certain use cases. Financial and real-estate transactions are often protected by paper-based controls. In commercial transactions, safety paper and signatures are utilized to facilitate detection of unauthorized alterations of information provided via paper document. Many techniques for casting votes leverage a physical paper ballot which may deposited into a ballot box to ultimately be counted.

### BRIEF SUMMARY

In general, various embodiments of the present disclosure provide methods, apparatus, systems, computing devices, computing entities, and/or the like for allowing a user to remotely verify a physical document.

In some embodiments, a computer-implemented method comprises: receiving, by one or more processors and from a user device, a remote document verification request indicating a subject document to be verified; transmitting, by the one or more processors and to the user device, an interface configured to receive user input corresponding to the subject document; receiving, by the one or more processors and via the transmitted interface, the user input corresponding to the subject document; generating, by the one or more processors and based on the subject document and the user input, an updated document; creating, by the one or more processors and via a printer device, a physical document corresponding to the updated document; providing, by the one or more processors and to the user device, a media feed displaying the physical document as it is created; and causing transmission, by the one or more processors and to the user device, of a prompt to be displayed to the user via which the user can indicate verification of the physical document.

In some embodiments, a computing apparatus comprises memory and one or more processors communicatively coupled to the memory, the one or more processors configured to: receive, from a user device, a remote document verification request indicating a subject document to be verified; transmit, to the user device, an interface configured to receive user input corresponding to the subject document; receive, via the transmitted interface, the user input corresponding to the subject document; generate, based on the subject document and the user input, an updated document; create, via a connected printer device, a physical document corresponding to the updated document; provide, to the user device, a media feed displaying the physical document as it is created; and cause transmission, to the client device, of a prompt to be displayed to the user via which the user can indicate verification of the physical document.

In some embodiments, one or more non-transitory computer-readable storage media including instructions that, when executed by one or more processors, cause the one or more processors to: receive, from a user device, a remote document verification request indicating a subject document to be verified; transmit, to the user device, an interface configured to receive user input corresponding to the subject document; receive, via the transmitted interface, the user input corresponding to the subject document; generate, based on the subject document and the user input, an updated document; create, via a connected printer device, a physical document corresponding to the updated document; provide, to the user device, a media feed displaying the physical document as it is created; and cause transmission, to the client device, of a prompt to be displayed to the user via which the user can indicate verification of the physical document.

### BRIEF DESCRIPTION OF THE DRAWINGS

FIG. 1 provides an example overview of an architecture in accordance with some embodiments of the present disclosure.

FIG. 2 provides an example document verification computing entity in accordance with some embodiments of the present disclosure.

FIG. 3 provides an example client computing entity in accordance with some embodiments of the present disclosure.

FIG. 4 provides an example verification apparatus in accordance with some embodiments of the present invention.

FIG. 5 is a flowchart diagram of an example process for performing predictive operations in accordance with some embodiments of the present disclosure.

### DETAILED DESCRIPTION

Various embodiments of the present disclosure are described more fully hereinafter with reference to the accompanying drawings, in which some, but not all embodiments of the present disclosure are shown. Indeed, the present disclosure may be embodied in many different forms and should not be construed as limited to the embodiments set forth herein; rather, these embodiments are provided so that this disclosure will satisfy applicable legal requirements. The term “or” is used herein in both the alternative and conjunctive sense, unless otherwise indicated. The terms “illustrative” and “example” are used to be examples with no indication of quality level. Terms such as “computing,” “determining,” “generating,” and/or similar words are used herein interchangeably to refer to the creation, modification, or identification of data. Further, “based on,” “based at least in part on,” “based at least on,” “based upon,” and/or similar words are used herein interchangeably in an open-ended manner such that they do not necessarily indicate being based only on or based solely on the referenced element or elements unless so indicated. Like numbers refer to like elements throughout.

### I. Computer Program Products, Methods, and Computing Entities

Embodiments of the present disclosure may be implemented in various ways, including as computer program products that comprise articles of manufacture. Such computer program products may include one or more software components including, for example, software objects, methods, data structures, or the like. A software component may be coded in any of a variety of programming languages. An illustrative programming language may be a lower-level programming language such as an assembly language associated with a particular hardware architecture and/or operating system platform. A software component comprising assembly language instructions may require conversion into executable machine code by an assembler prior to execution by the hardware architecture and/or platform. Another example programming language may be a higher-level programming language that may be portable across multiple architectures. A software component comprising higher-level programming language instructions may require conversion to an intermediate representation by an interpreter or a compiler prior to execution.

Other examples of programming languages include, but are not limited to, a macro language, a shell or command language, a job control language, a script language, a database query or search language, and/or a report writing language. In one or more example embodiments, a software component comprising instructions in one of the foregoing examples of programming languages may be executed directly by an operating system or other software component without having to be first transformed into another form. A software component may be stored as a file or other data storage construct. Software components of a similar type or functionally related may be stored together such as, for example, in a particular directory, folder, or library. Software components may be static (e.g., pre-established or fixed) or dynamic (e.g., created or modified at the time of execution).

A computer program product may include a non-transitory computer-readable storage medium storing applications, programs, program modules, scripts, source code, program code, object code, byte code, compiled code, interpreted code, machine code, executable instructions, and/or the like (also referred to herein as executable instructions, instructions for execution, computer program products, program code, and/or similar terms used herein interchangeably). Such non-transitory computer-readable storage media include all computer-readable media (including volatile and non-volatile media).

In some embodiments, a non-volatile computer-readable storage medium may include a floppy disk, flexible disk, hard disk, solid-state storage (SSS) (e.g., a solid-state drive (SSD), solid state card (SSC), solid state module (SSM), enterprise flash drive, magnetic tape, or any other non-transitory magnetic medium, and/or the like). A non-volatile computer-readable storage medium may also include a punch card, paper tape, optical mark sheet (or any other physical medium with patterns of holes or other optically recognizable indicia), compact disc read only memory (CD-ROM), compact disc-rewritable (CD-RW), digital versatile disc (DVD), Blu-ray disc (BD), any other non-transitory optical medium, and/or the like. Such a non-volatile computer-readable storage medium may also include read-only memory (ROM), programmable read-only memory (PROM), erasable programmable read-only memory (EPROM), electrically erasable programmable read-only memory (EEPROM), flash memory (e.g., Serial, NAND, NOR, and/or the like), multimedia memory cards (MMC), secure digital (SD) memory cards, SmartMedia cards, CompactFlash (CF) cards, Memory Sticks, and/or the like. Further, a non-volatile computer-readable storage medium may also include conductive-bridging random access memory (CBRAM), phase-change random access memory (PRAM), ferroelectric random-access memory (FeRAM), non-volatile random-access memory (NVRAM), magnetoresistive random-access memory (MRAM), resistive random-access memory (RRAM), Silicon-Oxide-Nitride-Oxide-Silicon memory (SONOS), floating junction gate random access memory (FJG RAM), Millipede memory, racetrack memory, and/or the like.

In some embodiments, a volatile computer-readable storage medium may include random access memory (RAM), dynamic random access memory (DRAM), static random access memory (SRAM), fast page mode dynamic random access memory (FPM DRAM), extended data-out dynamic random access memory (EDO DRAM), synchronous dynamic random access memory (SDRAM), double data rate synchronous dynamic random access memory (DDR SDRAM), double data rate type two synchronous dynamic random access memory (DDR2 SDRAM), double data rate type three synchronous dynamic random access memory (DDR3 SDRAM), Rambus dynamic random access memory (RDRAM), Twin Transistor RAM (TTRAM), Thyristor RAM (T-RAM), Zero-capacitor (Z-RAM), Rambus in-line memory module (RIMM), dual in-line memory module (DIMM), single in-line memory module (SIMM), video random access memory (VRAM), cache memory (including various levels), flash memory, register memory, and/or the like. It will be appreciated that where embodiments are described to use a computer-readable storage medium, other types of computer-readable storage media may be substituted for or used in addition to the computer-readable storage media described above.

As should be appreciated, various embodiments of the present disclosure may also be implemented as methods, apparatus, systems, computing devices, computing entities, and/or the like. As such, embodiments of the present disclosure may take the form of an apparatus, system, computing device, computing entity, and/or the like executing instructions stored on a computer-readable storage medium to perform certain steps or operations. Thus, embodiments of the present disclosure may also take the form of an entirely hardware embodiment, an entirely computer program product embodiment, and/or an embodiment that comprises combination of computer program products and hardware performing certain steps or operations.

Embodiments of the present disclosure are described below with reference to block diagrams and flowchart illustrations. Thus, it should be understood that each block of the block diagrams and flowchart illustrations may be implemented in the form of a computer program product, an entirely hardware embodiment, a combination of hardware and computer program products, and/or apparatus, systems, computing devices, computing entities, and/or the like carrying out instructions, operations, steps, and similar words used interchangeably (e.g., the executable instructions, instructions for execution, program code, and/or the like) on a computer-readable storage medium for execution. For example, retrieval, loading, and execution of code may be performed sequentially such that one instruction is retrieved, loaded, and executed at a time. In some example embodiments, retrieval, loading, and/or execution may be performed in parallel such that multiple instructions are retrieved, loaded, and/or executed together. Thus, such embodiments can produce specifically-configured machines performing the steps or operations specified in the block diagrams and flowchart illustrations. Accordingly, the block diagrams and flowchart illustrations support various combinations of embodiments for performing the specified instructions, operations, or steps.

### II. Example Framework

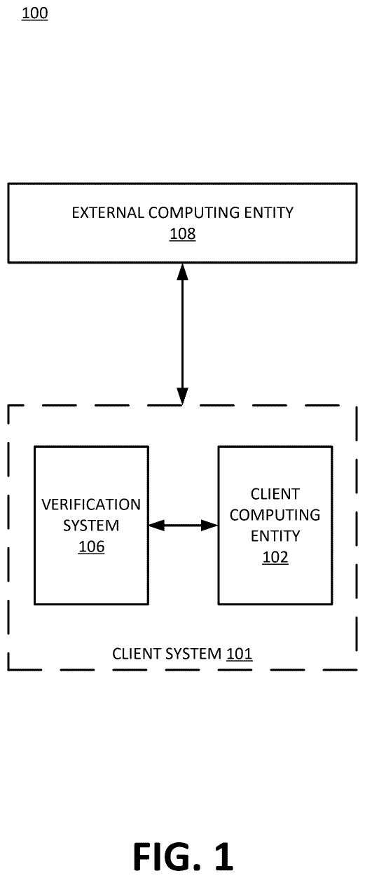

FIG. 1 provides an example overview of an architecture 100 in accordance with some embodiments of the present disclosure. The architecture 100 includes a client system 101 configured to receive requests, such as document verification requests, via the external computing entity 108, process the requests to generate physical documents, and provide verification of the generated physical documents to the external computing entity 108. The example architecture 100 may be used in a plurality of domains and not limited to any specific application as disclosed herewith. The plurality of domains may include banking, healthcare, real estate, education, retail, to name a few.

In some embodiments, the client system 101 may communicate with the external computing entity 108 using one or more communication networks. Examples of communication networks include any wired or wireless communication network including, for example, a wired or wireless local area network (LAN), personal area network (PAN), metropolitan area network (MAN), wide area network (WAN), or the like, as well as any hardware, software, and/or firmware required to implement it (such as, e.g., network routers, and/or the like).

The client system 101 may include a verification system 106 and one or more client computing entities 102. The verification system 106 and/or one or more client computing entities 102 may be individually and/or collectively configured to receive data objects, a verification request for an entity, and/or the like, from external computing entity 108, for example, process the data objects, verification request, and/or the like to generate outputs, such as a physical document corresponding to the verification request and a verification result, and provide the generated outputs to the client computing entity 102.

In some embodiments, the client system 101, client computing entity 102, verification system 106 and/or one or more external computing entities 108 are communicatively coupled using one or more wired and/or wireless communication techniques. The respective computing entities may be specially configured to perform one or more steps/operations of one or more techniques described herein.

In some embodiments, either of the client computing entity 102 and/or the client system 101 may be embodied as an artificial intelligence (AI) computing entity (e.g., machine-learned model, an intelligent agent, and the like. As such, either of client computing entity 102 and/or client system 101 may be configured to provide and/or receive data from a user via one or more input/output mechanisms. Suitable input/output mechanisms may include, but are not limited to, a display, a camera, a speaker, a voice-activated input, and/or the like. In at least some embodiments, an AI computing entity/AI computing system may utilize a set of predefined and executable program algorithms. Such program algorithms may be stored within an onboard memory storage component, accessible via a network, and the like. In some embodiments, such an AI computing entity may be configured to receive/execute one or more of the program algorithms responsive to detecting the occurrence of a predefined trigger event.

As used herein, the terms “artificial intelligence”, “artificial intelligence component”, “artificial intelligence system”, “artificial intelligence computing entity”, and the like may comprise one or more machine-learned models. Up to each machine-learned model may include an architecture, either hardware or software, comprising a set of parameters and/or a set of structural hyperparameters. The set of parameters may include coefficients, weights, biases, activation functions, action function types (in embodiments wherein an activation function and/or function type are determined during training), clustering centroids, medoids, partitions, tree data (number of trees, tree depth, and the like), split parameters, and the like. In at least some embodiments, the set of parameters may include parameters which have been determined based on training the one or more machine-learned models based at least in part on a set of training hyperparameters and/or by utilizing the machine-learned model according to the set of training hyperparameters. In at least some embodiments, the set of structural hyperparameters may comprise hyperparameters defining the machine-learned model's architecture.

In at least some embodiments, the set of structural hyperparameters may define one or more features/components of the model's architecture. For example, a hyperparameter may indicate a configuration or order defining dataflow amongst the components of a model; that is, which input(s) are provided to a first component, and which output(s) of the first component become input to a second component, and so on. In some embodiments, the set of structural hyperparameters includes a number, type, and/or configuration of component(s) per layer. In some embodiments, the set of structural hyperparameters includes a number of layers of the model, a number and/or type of input nodes within a layer of the model, a number/type of nodes within a layer, a number of trees, tree data, a minimum number of samples in a leaf node of a tree, and/or the like. Up to each component of a machine-learned model may utilize one or more activation functions/activation function types, one or more attention mechanism(s)/attention mechanism types, node and split indications, probabilities within a decision tree, and the like. Combinations of any of these aforementioned components, and any additional number of components not mentioned herein, may result in different model architecture types, including transformer-based models, neural networks, multi-layer perceptrons, clustering algorithms, support vector machines, gradient boosting machines, and the like.

Training hyperparameter(s) may be used to train and otherwise determine a subject machine-learned model. In some embodiments, training parameters are used along with training data and/or input data to determine the parameter(s) of the subject model. As such, a different set of training hyperparameters, when utilized to train a first model and a second model with a same architecture using a same set of training data, may ultimately lead to parameters of the first model differing from the parameters of the second model, and as such, the first model and the second model may generate different outputs from one another.

In some embodiments, training hyperparameters may include a train-test split ratio, an activation function/activation function type, training stages, batch size(s), training epochs, a configured loss function, component(s) of the machine-learned model which are altered according to the loss function with respect to one or more batches/epochs of training, learning rate, learning rate scheduling, and so on. In at least some embodiments, the structural hyperparameters and/or the training hyper parameters may be determined by an optimization algorithm and/or based on user input. In some embodiments, any number of the logic, component(s), routines, and/or the like as described herein may be implemented as a machine-learned model.

In some example embodiments, the verification system 106 may be configured to receive and/or transmit one or more datasets, objects, and/or the like from and/or to the external computing entities 108 to perform one or more steps/operations of one or more techniques described herein. The external computing entities 108, for example, may include and/or be associated with one or more entities that may be configured to receive and display an interface for remote document verification.

### A. Example Client Computing Entity

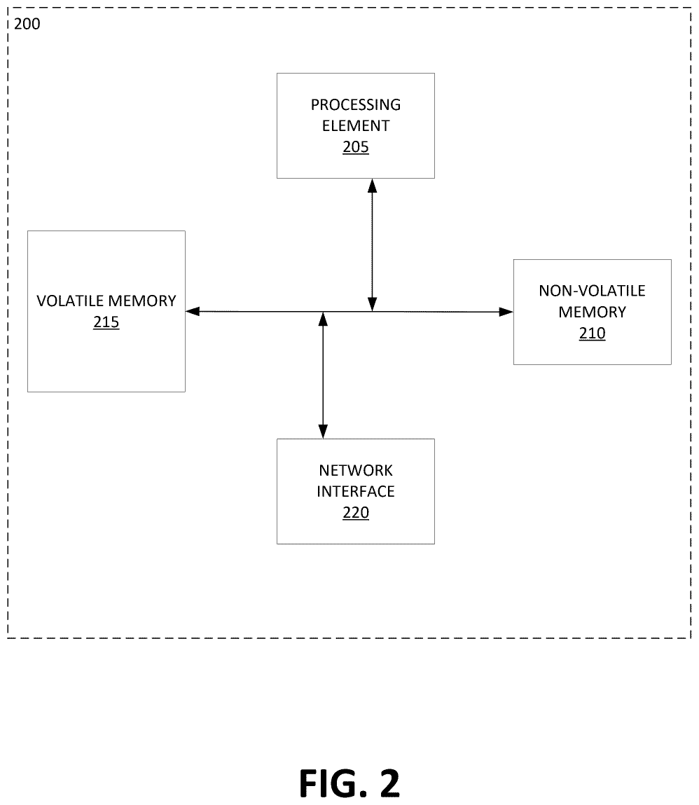

FIG. 2 provides an example computing entity 200 in accordance with some embodiments of the present disclosure. The computing entity 200 is an example of the client computing entity 102 and/or external computing entity 108 of FIG. 1. In general, the terms computing entity, computer, entity, device, system, and/or similar words used herein interchangeably may refer to, for example, one or more computers, computing entities, desktops, mobile phones, tablets, phablets, notebooks, laptops, distributed systems, kiosks, input terminals, servers or server networks, blades, gateways, switches, processing devices, processing entities, set-top boxes, relays, routers, network access points, base stations, the like, and/or any combination of devices or entities adapted to perform the functions, operations, and/or processes described herein.

As shown in FIG. 2, in some embodiments, the computing entity 200 may include, or be in communication with, one or more processing elements 205 (also referred to as processors, processing circuitry, and/or similar terms used herein interchangeably) that communicate with other elements within the computing entity 200 via a bus, for example. As will be understood, the processing element 205 may be embodied in a number of different ways.

For example, the processing element 205 may be embodied as one or more complex programmable logic devices (CPLDs), microprocessors, multi-core processors, coprocessing entities, application-specific instruction-set processors (ASIPs), microcontrollers, and/or controllers. Further, the processing element 205 may be embodied as one or more other processing devices or circuitry. The term circuitry may refer to an entirely hardware embodiment or a combination of hardware and computer program products. Thus, the processing element 205 may be embodied as integrated circuits, application specific integrated circuits (ASICs), field programmable gate arrays (FPGAs), programmable logic arrays (PLAs), hardware accelerators, other circuitry, and/or the like.

As will therefore be understood, the processing element 205 may be configured for a particular use or configured to execute instructions stored in volatile or non-volatile media or otherwise accessible to the processing element 205. As such, whether configured by hardware or computer program products, or by a combination thereof, the processing element 205 may be capable of performing steps or operations according to embodiments of the present disclosure when configured accordingly.

In some embodiments, the computing entity 200 may further include, or be in communication with, non-volatile media (also referred to as non-volatile storage, memory, memory storage, memory circuitry, and/or similar terms used herein interchangeably). In some embodiments, the non-volatile media may include one or more non-volatile memory 210, including, but not limited to, hard disks, ROM, PROM, EPROM, EEPROM, flash memory, MMCs, SD memory cards, Memory Sticks, CBRAM, PRAM, FeRAM, NVRAM, MRAM, RRAM, SONOS, FJG RAM, Millipede memory, racetrack memory, and/or the like.

As will be recognized, the non-volatile media may store databases, database instances, database management systems, data, applications, programs, program modules, scripts, code (e.g., source code, object code, byte code, compiled code, interpreted code, machine code, etc.) that embodies one or more computer functions described herein, executable instructions, and/or the like. The term database, database instance, database management system, and/or similar terms used herein interchangeably, may refer to a collection of records or data that is stored in a computer-readable storage medium using one or more database models; such as a hierarchical database model, network model, relational model, entity-relationship model, object model, document model, semantic model, graph model, and/or the like.

In some embodiments, the computing entity 200 may further include, or be in communication with, volatile media (also referred to as volatile storage, memory, memory storage, memory circuitry, and/or similar terms used herein interchangeably). In some embodiments, the volatile media may also include one or more volatile memory 215, including, but not limited to, RAM, DRAM, SRAM, FPM DRAM, EDO DRAM, SDRAM, DDR SDRAM, DDR2 SDRAM, DDR3 SDRAM, RDRAM, TTRAM, T-RAM, Z-RAM, RIMM, DIMM, SIMM, VRAM, cache memory, register memory, and/or the like.

As will be recognized, the volatile storage or memory media may be used to store at least portions of the databases, database instances, database management systems, data, applications, programs, program modules, code (source code, object code, byte code, compiled code, interpreted code, machine code) that embodies one or more other computer functions described herein, executable instructions, and/or the like being executed by, for example, the processing element 205. Thus, the databases, database instances, database management systems, data, applications, programs, program modules, code (source code, object code, byte code, compiled code, interpreted code, machine code) that embodies one or more computer functions described herein, executable instructions, and/or the like may be used to control certain aspects of the operation of the computing entity 200 with the assistance of the processing element 205 and operating system.

As indicated, in some embodiments, the computing entity 200 may also include one or more network interfaces 220 for communicating between various computing entities (e.g., the client computing entity 102, external computing entities, etc.), such as by communicating data, code, content, information, and/or similar terms used herein interchangeably that may be transmitted, received, operated on, processed, displayed, stored, and/or the like. Such communication may be executed using a wired data transmission protocol, such as fiber distributed data interface (FDDI), digital subscriber line (DSL), Ethernet, asynchronous transfer mode (ATM), frame relay, data over cable service interface specification (DOCSIS), or any other wired transmission protocol. In some embodiments, the computing entity 200 communicates with another computing entity for uploading or downloading data or code. Similarly, the computing entity 200 may be configured to communicate via wireless external communication networks using any of a variety of protocols, such as general packet radio service (GPRS), Universal Mobile Telecommunications System (UMTS), Code Division Multiple Access 2000 (CDMA2000), CDMA2000 1X (1xRTT), Wideband Code Division Multiple Access (WCDMA), Global System for Mobile Communications (GSM), Enhanced Data rates for GSM Evolution (EDGE), Time Division-Synchronous Code Division Multiple Access (TD-SCDMA), Long Term Evolution (LTE), Evolved Universal Terrestrial Radio Access Network (E-UTRAN), Evolution-Data Optimized (EVDO), High Speed Packet Access (HSPA), High-Speed Downlink Packet Access (HSDPA), IEEE 802.11 (Wi-Fi), Wi-Fi Direct, 802.16 (WiMAX), ultra-wideband (UWB), infrared (IR) protocols, near field communication (NFC) protocols, Wibree, Bluetooth protocols, wireless universal serial bus (USB) protocols, and/or any other wireless protocol.

Although not shown, the computing entity 200 may include, or be in communication with, one or more input elements, such as a keyboard input, a mouse input, a touch screen/display input, motion input, movement input, audio input, pointing device input, joystick input, keypad input, and/or the like. The computing entity 200 may also include, or be in communication with, one or more output elements (not shown), such as audio output, video output, screen/display output, motion output, movement output, and/or the like.

### B. Example External Computing Entity

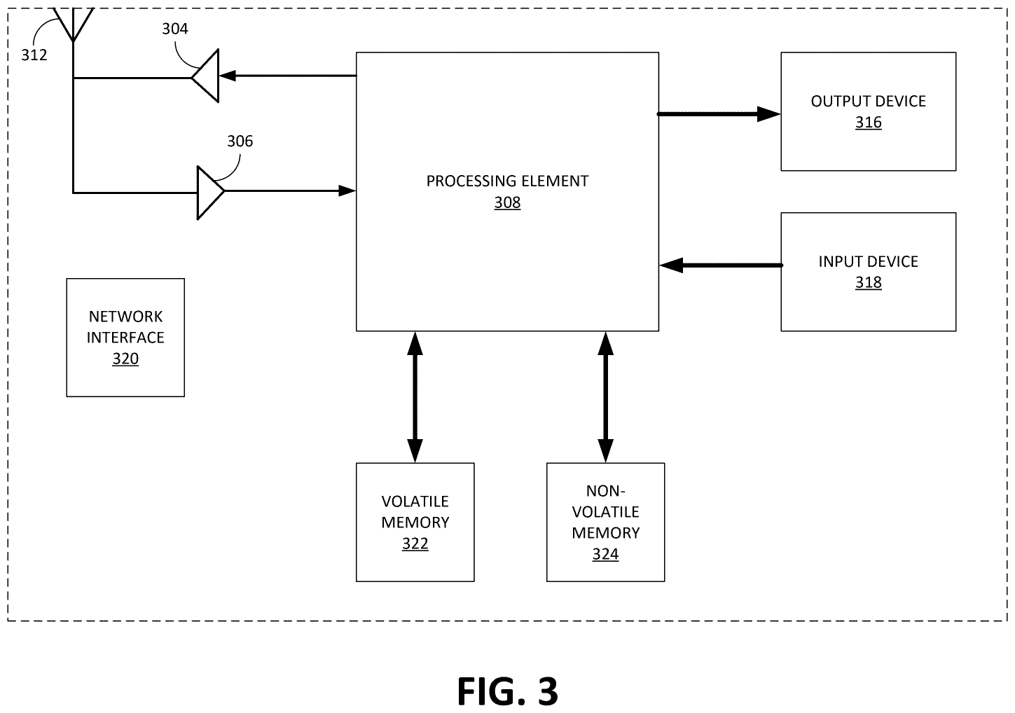

FIG. 3 provides an example external computing entity in accordance with some embodiments of the present disclosure. In general, the terms device, system, computing entity, entity, and/or similar words used herein interchangeably may refer to, for example, one or more computers, computing entities, desktops, mobile phones, tablets, phablets, notebooks, laptops, distributed systems, kiosks, input terminals, servers or server networks, blades, gateways, switches, processing devices, processing entities, set-top boxes, relays, routers, network access points, base stations, the like, and/or any combination of devices or entities adapted to perform the functions, operations, and/or processes described herein. External computing entities 108 may be operated by various parties. As shown in FIG. 3, the external computing entity 108 may include an antenna 312, a transmitter 304 (e.g., radio), a receiver 306 (e.g., radio), and a processing element 308 (e.g., CPLDs, microprocessors, multi-core processors, coprocessing entities, ASIPs, microcontrollers, and/or controllers) that provides signals to and receives signals from the transmitter 304 and receiver 306, correspondingly.

The signals provided to and received from the transmitter 304 and the receiver 306, correspondingly, may include signaling information/data in accordance with air interface standards of applicable wireless systems. In this regard, the external computing entity 108 may be capable of operating with one or more air interface standards, communication protocols, modulation types, and access types. More particularly, the external computing entity 108 may operate in accordance with any of a number of wireless communication standards and protocols, such as those described above with regard to the computing entity 200. In some embodiments, the external computing entity 108 may operate in accordance with multiple wireless communication standards and protocols, such as UMTS, CDMA2000, 1xRTT, WCDMA, GSM, EDGE, TD-SCDMA, LTE, E-UTRAN, EVDO, HSPA, HSDPA, Wi-Fi, Wi-Fi Direct, WiMAX, UWB, IR, NFC, Bluetooth, USB, and/or the like. Similarly, the external computing entity 108 may operate in accordance with multiple wired communication standards and protocols, such as those described above with regard to the computing entity 200 via a network interface 320.

Via these communication standards and protocols, the external computing entity 108 may communicate with various other entities using mechanisms such as Unstructured Supplementary Service Data (USSD), Short Message Service (SMS), Multimedia Messaging Service (MMS), Dual-Tone Multi-Frequency Signaling (DTMF), and/or Subscriber Identity Module Dialer (SIM dialer). The client computing entity 102 may also download code, changes, add-ons, and updates, for instance, to its firmware, software (e.g., including executable instructions, applications, program modules), and operating system.

According to some embodiments, the external computing entity 108 may include location determining aspects, devices, modules, functionalities, and/or similar words used herein interchangeably. The location determining aspects of the external computing entity 108 may be used to determine an appropriate set of rules governing remote document verification, such as in embodiments wherein the verification is required by an entity whose rules vary according to location (for example, wherein the form verification is different from state to state). For example, the external computing entity 108 may include outdoor positioning aspects, such as a location module adapted to acquire, for example, latitude, longitude, altitude, geocode, course, direction, heading, speed, universal time (UTC), date, and/or various other information/data. In some embodiments, the location module may acquire data, sometimes known as ephemeris data, by identifying the number of satellites in view and the relative positions of those satellites (e.g., using global positioning systems (GPS)). The satellites may be a variety of different satellites, including Low Earth Orbit (LEO) satellite systems, Department of Defense (DOD) satellite systems, the European Union Galileo positioning systems, the Chinese Compass navigation systems, Indian Regional Navigational satellite systems, and/or the like. This data may be collected using a variety of coordinate systems, such as the Decimal Degrees (DD); Degrees, Minutes, Seconds (DMS); Universal Transverse Mercator (UTM); Universal Polar Stereographic (UPS) coordinate systems; and/or the like. Alternatively, the location information/data may be determined by triangulating the position of the external computing entity 108 in connection with a variety of other systems, including cellular towers, Wi-Fi access points, and/or the like. Similarly, the external computing entity 108 may include indoor positioning aspects, such as a location module adapted to acquire, for example, latitude, longitude, altitude, geocode, course, direction, heading, speed, time, date, and/or various other information/data. Some of the indoor systems may use various position or location technologies including RFID tags, indoor beacons or transmitters, Wi-Fi access points, cellular towers, nearby computing devices (e.g., smartphones, laptops), and/or the like. For instance, such technologies may include the iBeacons, Gimbal proximity beacons, Bluetooth Low Energy (BLE) transmitters, NFC transmitters, and/or the like. These indoor positioning aspects may be used in a variety of settings to determine the location of someone or something to within inches or centimeters.

The external computing entity 108 may also comprise a user interface (that may include an output device 316 (e.g., display, speaker, tactile instrument, etc.) coupled to a processing element 308) and/or a user input interface (coupled to a processing element 308). For example, the user interface may be a user application, browser, user interface, and/or similar words used herein interchangeably executing on and/or accessible via the external computing entity 108 to interact with and/or cause display of information/data from the computing entity 200, as described herein. The user input interface may comprise any of a plurality of input devices 318 (or interfaces) allowing the external computing entity 108 to receive code and/or data, such as a keypad (hard or soft), a touch display, voice/speech or motion interfaces, or other input device. In some embodiments including a keypad, the keypad may include (or cause display of) the conventional numeric (0-9) and related keys (#,*), and other keys used for operating the client computing entity 102 and may include a full set of alphabetic keys or set of keys that may be activated to provide a full set of alphanumeric keys. In addition to providing input, the user input interface may be used, for example, to activate or deactivate certain functions, such as screen savers and/or sleep modes.

The external computing entity 108 may also include volatile memory 322 and/or non-volatile memory 324, which may be embedded and/or may be removable. For example, the non-volatile memory 324 may be ROM, PROM, EPROM, EEPROM, flash memory, MMCs, SD memory cards, Memory Sticks, CBRAM, PRAM, FeRAM, NVRAM, MRAM, RRAM, SONOS, FJG RAM, Millipede memory, racetrack memory, and/or the like. The volatile memory 322 may be RAM, DRAM, SRAM, FPM DRAM, EDO DRAM, SDRAM, DDR SDRAM, DDR2 SDRAM, DDR3 SDRAM, RDRAM, TTRAM, T-RAM, Z-RAM, RIMM, DIMM, SIMM, VRAM, cache memory, register memory, and/or the like. The volatile and non-volatile memory may store databases, database instances, database management systems, data, applications, programs, program modules, scripts, code (source code, object code, byte code, compiled code, interpreted code, machine code, etc.) that embodies one or more computer functions described herein, executable instructions, and/or the like to implement the functions of the external computing entity 108. As indicated, this may include a user application that is resident on the external computing entity 108 or accessible through a browser or other user interface for communicating with the computing entity 200 and/or various other computing entities.

In another embodiment, the external computing entity 108 may include one or more components or functionalities that are the same or similar to those of the computing entity 200, as described in greater detail above. As will be recognized, these architectures and descriptions are provided for example purposes only and are not limited to the various embodiments.

In various embodiments, the external computing entity 108 may be embodied as an artificial intelligence (AI) computing entity. Accordingly, the external computing entity 108 may be configured to provide and/or receive information/data from a user via an input/output mechanism, such as a display, a camera, a speaker, a voice-activated input, and/or the like. In certain embodiments, an AI computing entity may comprise one or more predefined and executable program algorithms stored within an onboard memory storage module, and/or accessible over a network. In various embodiments, the AI computing entity may be configured to retrieve and/or execute one or more of the predefined program algorithms upon the occurrence of a predefined trigger event.

### C. Example Verification System

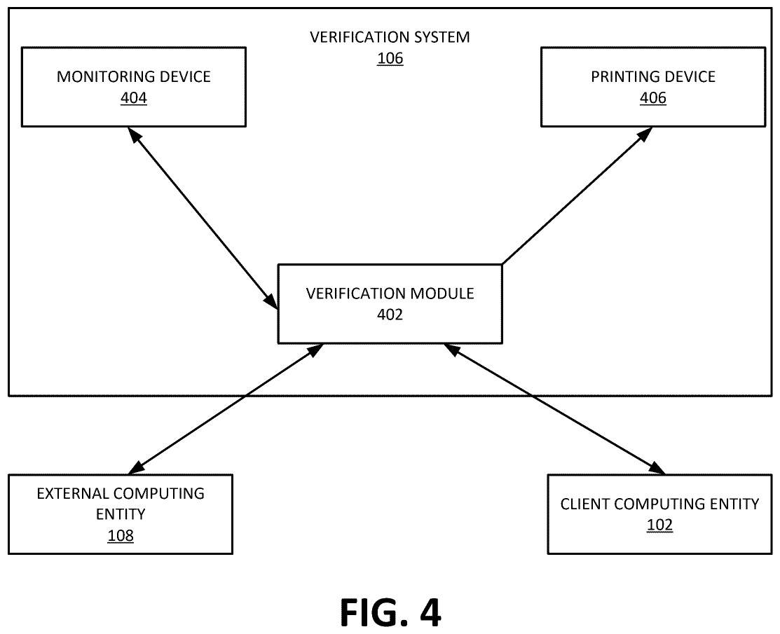

FIG. 4 provides an example verification system 106 in accordance with some embodiments of the present invention. As depicted, the example verification system 106 includes a verification module 402, a monitoring device 404, and a printing device 406. The verification module 402 may be configured to communicate with each of the monitoring device 404 and the printing device 406, as well as an external computing entity 108 and/or a client computing entity 102. Generally, verification system 106 may be configured to both create a physical document and enable a user to verify the created physical document.

Verification module 402 may be configured to receive a document verification request from a computing entity such as client computing entity 102 and/or external computing entity 108. Responsive to the received request, verification module 402 may be configured to provide an interface to external computing entity 108 via which a user can provide updated information corresponding to a subject document, thereby creating an updated document. Verification module 402 may further be configured to provide instruction to printing device 406 to create a physical document corresponding to the created updated document. Further, verification module 402 may be configured to receive a media feed from monitoring device 404 corresponding to the creation of the physical document by printing device 406. In at least some embodiments, verification module 402 is configured to provide at least a segment of the received media feed from monitoring device 404 to external computing entity 108 and/or client computing entity 102, such that a user of the computing entity may view the received media feed and indicate validation of the created document. Verification module 402 may further be configured to provide a prompt to a user via either external computing entity 108 or client computing entity 102 via which the user can indicate whether the created physical document is valid.

Printing device 406 may be a printer configured to receive printing instructions from verification module 402 with respect to the depicted embodiment. In at least some embodiments, printing device 406 is configured to create a physical document corresponding to a version of the subject document updated to reflect the user interactions/user provided information. Printing device 406 may be configured to print the physical document one line/section at a time, such that a user may indicate an invalidation immediately responsive to a section of the printed physical document appearing incorrectly. As such, the timing of the user's invalidation can be leveraged to determine which section of the document contains an error. Monitoring device 404 may be a camera that is situated such that the camera's feed displays the output of printing device 406. For example, monitoring device 404 may be configured such that it records the tray of printing device 406 where the physical document appears once it is printed.

Monitoring device 404 may be implemented as an entirely separate device from printing device 406 simply positioned to display the output of printing device 406 or may be a camera integrated within the printing device 406 intended to display the output tray/mechanism of the printing device 406 for purposes of enabling user validation.

### III. Examples of Certain Terms

In some embodiments, the terms “client system,” “client computing system,” “client computing entity,” and “client device” may refer to any system configured to run a remote document verification application as described herein. In some embodiments, the client system may be a server system including a verification system configured to enable remote verification of a physical document, the verification system comprising a connected printer and/or camera configured for document verification. In general, the client system may refer to any system capable of providing an interface to a user device via which a user can interact with a subject document, creating an updated document according to the user's interactions with the interface, and communicating with a validation system comprising a printer configured to create a physical document corresponding to the updated document and, in some embodiments, a camera configured to provide a media feed depicting the creation of the physical document. In at least some embodiments, the client system may additionally be configured to transmit a prompt to an external device via which the user can either validate or reject the created document.

In some embodiments, the term “external system” may refer to any system via which a user can access an interface transmitted by the client system to verify a document remotely. In at least some embodiments, an external system may be another system within a network of systems that includes the client system as well, wherein the external system is configured to communicate with the client system as part of a remote document verification method. In such embodiments, the external system may additionally be configured to receive a media stream from a camera configured to display printer output such that a user of the external system may visually confirm the creation of the subject physical document. The external system may additionally be configured to provide document content directly to the printer such that the physical document may be created to reflect said document content. In other embodiments, the external system's communication with the camera and/or the printer may be facilitated through the client system, such that the client system can enforce certain security protocols with respect to the communications, for example.

In some embodiments, the term “personal device” may refer to a device corresponding to a user via which a user can validate their identity. For example, a personal device may correspond to a cell phone registered to a user, such that an authentication code can be sent to the cell phone to verify that a current remote document verification session is indeed being conducted by the appropriate user. Generally, a “personal device” refers to any device via which the user can verify their own identity.

In some embodiments, the term “validation system” may refer to a system configured for creating a physical document corresponding to a subject document as provided or edited by a user. In at least some embodiments, a validation system includes a printer configured to print a physical document corresponding to the subject document. A validation system may additionally include a camera attached to the printer or otherwise situated with respect to the printer such that the printer output feed/tray/mechanism is visible via an area captured by the camera. A validation system may additionally be configured to provide an audio transcription of any content displayed by the physical document.

In some embodiments, the terms “verification,” “validation,”, and “authentication” may refer to the process of confirming that a document reflects accurate information and/or information as intended to be documented by the user. Verification, as used herein, may refer to a process for querying a user regarding a created document, for example, such that the user can provide an indication of whether the created document accurately reflects intended information. In some embodiments, verification includes prompting the user to provide an indication, via a provided interface, for example, that the created document is verified. In other embodiments, verification includes providing the user with a mechanism via which they can reject or invalidate the document, and wherein a document is verified in the absence of a user invalidation/rejection.

In some embodiments, the term “physical document” refers to a printed document comprising sections of text, images, and the like. A corresponding “digital document,” “digital version”, and/or “digital representation” of said physical document refers to a file configured to be displayed by a computer, such that the computer will display those same sections of text, images, and the like of the corresponding physical document.

### IV. Overview, Technical Improvements, and Technical Advantages

Various embodiments of the present disclosure make important technical contributions to fields and/or environments requiring verified physical documents.

For example, various embodiments of the present disclosure improve systems which require physical documents which must be verified by a user located remotely from a location requiring the physical documents. Current systems for “remote document verification” are directed towards verifying a digital version of a document, for example, rather than any physical document created from the digital version. Further, these systems for verifying digital versions of a document and potentially subsequently creating a corresponding physical version offer no features which ensure the physical document is properly submitted or otherwise accounted for.

However, in accordance with various embodiments of the present disclosure, a system and method are disclosed enabling a user to remotely verify a physical document itself, rather than a digital document which is intended to be converted into a physical document. Further, in some embodiments, the techniques as described may enable a user to visually confirm submission of their verified document. Enabling remote verification of both documents and document submission in this manner improves the security and accuracy of any system or process requiring verified physical documents, as the user is able to verify the physical document itself rather than a digital version or representation of the document.

### V. Example System Operations

As indicated, various embodiments of the present disclosure make important technical contributions to enabling remote verification of physical documents. In particular, a remote document verification system 400 is disclosed herein, capable of creating a physical document which can be verified by a corresponding user as it is created.

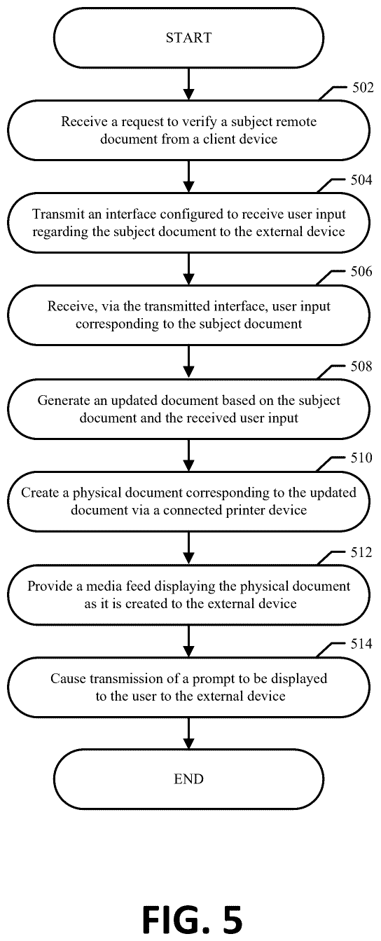

FIG. 5 is a flowchart diagram of an example process 500 for remote document verification. It should be appreciated that, with respect to example process 500, the client computing entity 102 is configured to facilitate communication between verification system 106 and external computing entity 108. In other embodiments of the example process 500, the external computing entity 108 (user device) may be configured to communicate directly with the verification system 106 at times, thereby conducting some operations as described below as being taken instead by the client computing entity 102. In some embodiments, the process 500 begins at step/operation 502 when the client computing entity 102 receives a remote verification request from a client device. In at least some embodiments, the remote verification request indicates a subject remote document to be verified.

In some embodiments, at step/operation 504, the client computing entity 102 transmits an interface to the user device. In at least some embodiments, the transmitted interface is configured to receive user input corresponding to the subject document. For example, the transmitted interface may include one or more drop down boxes corresponding to one or more data fields, the drop-down boxes each enabling a user to choose between one or more pre-defined options. In at least some embodiments, the transmitted interface includes an entry area allowing a user to enter one or more characters. The transmitted interface may include a digital representation of the subject document. In some embodiments, the digital representation of the subject document may include data entry fields in one or more areas of the subject document requiring user input (such as areas requiring a user selection or a user signature, for example). The transmitted interface may be configured to receive input via one or more input devices of the user device or may be configured to provide an on-screen input interface, such as a selectable keyboard.

In some embodiments, at step/operation 506, the client computing entity 102 receives, via the transmitted interface, user input corresponding to the subject document. The client computing entity 102 may be configured to process user interactions with, for example, the digital representation of the subject document via an input device of the user device or via a provided on-screen input interface. In general, receiving user input corresponding to the subject document includes receiving one or more user interactions with the transmitted interface corresponding to the digital representation of the subject document.

In some embodiments, at step/operation 508, the client computing entity 102 generates an updated document based on the subject document and the received user input. In at least some embodiments, the client computing entity 102 identifies one or more editable fields of the subject document and one or more user interactions corresponding to each of the one or more editable fields. The client computing entity 102 may be configured to leave any editable field blank and/or unaltered if no user interactions are detected corresponding to said editable field. In general, generating an updated document based on the subject document and the received user input may include determining which editable field each user interaction corresponds to, and updating said field(s) to reflect the content of the user interaction to provide an updated document.

In some embodiments, at step/operation 510, the client computing entity 102 creates a physical document corresponding to the updated document. In at least some embodiment, the client computing entity 102 is configured to transmit the updated document to a printer device for printing. The printer device may be a component of a verification system or may simply be any printer device with which the client computing entity 102 can communicate. In general, creating a physical document corresponding to the updated document includes printing a physical version of the updated document which reflects the user's interactions and edits to the subject document. In at least some embodiments, creating a physical document includes creating the physical document with an identifying mark or label corresponding to the user of the external device, such that the user can confirm that the physical document corresponds to their submission/edits.

In at least some embodiments, the client computing entity 102 may be configured to receive user interactions with respect to a single editable field or line at a time and thus create the updated document one section (editable field, line, etc.) at a time, rather than receiving user interactions with all of the fields all at once and subsequently creating an entire updated document. In such embodiments, the client computing entity 102 may be configured to provide a section of the updated document to the printing device as soon as it is created, such that the printing device will print one section of the updated document at a time. By printing one section at a time, the client computing entity 102 allows a user to interrupt the creation of the physical document before it is completed if there is an error, thereby leading to the creation of an incomplete and therefore invalid document in the presence of an error rather than a seemingly valid complete document comprising one or more errors.

In at least some embodiments, at step/operation 512, the client computing entity 102 may be configured to provide a media feed displaying the physical document as it is created to the external device. The client computing entity 102 may be connected to, or otherwise in communication with, a camera configured to monitor and display the printing device's output. As such, the client computing entity 102 may be configured to provide a media stream from the camera to the external device, such that the user device may visually confirm the printing/creation of a physical document reflecting the updates to the subject document they provided via the interface. In at least some embodiments, the client computing entity 102 may be configured to analyze the media feed from the camera before providing the feed, such that the client computing entity 102 can verify that no unwanted data (for example, data from a previous document still visible in a printing tray) is unintentionally displayed to the user. In at least some embodiments, the client computing entity 102 is configured to trim the camera feed to include only the segment depicting the creation of the subject document, thereby minimizing the size of the transmitted feed. In at least some embodiments, such as those where network considerations limit the ability to transmit video and/or those where a user requires an audio feed rather than a video feed, for example, the client computing entity 102 may be configured to provide an audio feed including screen reader output corresponding to the document as displayed by the camera feed.

In at least some embodiments, at step/operation 514, the client computing entity 102 may be configured to cause transmission of a prompt to be displayed to the user via the external device. The client computing entity 102 may be configured to generate a prompt requesting that the user indicate whether or not the physical document as displayed by the camera feed is accurate. Responsive to a positive indication with respect to the prompt, the client computing entity 102 may be configured to report and/or label the document as verified, validated, authenticated, etc. Responsive to a negative indication from the user with respect to the prompt, the client computing entity 102 may be configured to report and or label the document as rejected, invalid, etc.

In at least some embodiments, the client computing entity 102 is additionally configured to verify an identity of the user attempting to generate the remote document. In at least some embodiments, verifying the user identity may include providing an authorization prompt to at least one device associated with the user, such as a personal device or mobile phone. Such verification may include providing a code or other authorization mechanism to the user's personal device and requiring entry of the code via the presented user interface. Upon receipt of the correct code, the client computing entity 102 may be configured to continue with the document generation/verification process.

In at least some embodiments, the client computing entity 102 is configured for one or more identity verification functions. The client computing entity 102 may be configured to verify a user's identity relative to a reference image, such as a presented user identification document or a user image on record. As such, the client computing entity 102 may be configured to capture a live photo or a video frame of the user's face. In at least some embodiments, the client computing entity 102 is configured to check for liveness relative to the user photo, thereby preventing use of a photo or a mask. The client computing entity 102 may further be configured to execute one or more image preprocessing functions, including face detection (locating a face in an image), facial alignment (adjusting the face's orientation, tilt, or rotation), and/or normalization (standardizing lighting, size, and/or position). The client computing entity 102 may further be configured to extract features from the captured/received image, and convert such features into a facial template (e.g., a numerical representation of unique features) by analyzing key points such as the distance between eyes, jawline shape, texture patterns, and the like using one or more AI models. The client computing entity 102 may further be configured to access a reference image (an ID document, stored database photo, prior enrollment photo, or the like), and execute the same preprocessing/feature extraction steps with respect to the reference image.

In at least some embodiments, the client computing entity 102 executes a comparison between the live facial template and the created reference template, thereby creating a similarity score. The similarity score may be compared to a threshold similarity score to determine whether the user is verified. Such a verification step may occur at any point with respect to the method(s) as previously described, and may occur simultaneously with other defined steps to enable the workflows to be uninterrupted and completed without delay. If the user's identity is indeed verified at any point, the method(s) as described above continue uninterrupted. If the user's identity cannot be verified, the method(s) as described may halt immediately and void any input generated by the unverified user. In at least some embodiments, an unverified user may further be flagged by the system for subsequent remediation.

While the embodiment as described above indicates many actions of the client computing entity 102 transmitting and/or providing content to an external computing entity 108, it should be appreciated that, in additional embodiments, such as those where the user interacts directly with the client computing entity 102, the actions of the external device may be taken with respect to the client computing entity 102 itself. For example, in an embodiment where the user interacts with client computing entity 102 directly, client computing entity 102 may be configured to provide an interface to the user via components of the client computing entity 102 itself, and the like.

Similarly, while the embodiment as described above indicates many actions taken by the client computing entity 102, in additional embodiments wherein a verification system 106 is configured to communicate directly with the external computing entity 108, for example, any of the steps of process 500 described as taken by the client computing entity 102 may instead be conducted by the verification system 106.

Accordingly, as described above, various embodiments of the present disclosure make important technical contributions to improving techniques for verifying documents in situations where a user verifying the document is located separately from the subject document(s). It is well understood in the art that, while physical documents are still prevalent in some fields, there are many circumstances under which it may be difficult for a user to be collocated with an entity requiring the physical documents. Accordingly, there exists a need for providing a platform for creating a physical document corresponding to a subject user which the subject user can verify remotely. The techniques as described herein enable continued utilization of physical documents in fields where it is beneficial/necessary to do so, while still allowing users to verify the documents from a remote location. Accordingly, the techniques described herein improve the security and the extendibility of services requiring physical documents verified by a remote user.

In at least one embodiment, the techniques as disclosed herein are implemented with respect to a voting/balloting process. For example, a user may be provided with an interface via which they can provide their selections corresponding to a subject election. As the user makes their selections, the media feed may be provided displaying the printed ballot indicating the user's selections as they are provided. The printer may be configured to print a paper ballot indicating the user's selections. Further, a verification system configured for remote document verification with respect to a balloting process may additionally include a mechanism for depositing the printed ballot into a secure deposit (a movable tray which can deposit the printed document into a ballot box, for example).

### VI. Conclusion

Many modifications and other embodiments will come to mind to one skilled in the art to which this disclosure pertains having the benefit of the teachings presented in the foregoing descriptions and the associated drawings. Therefore, it is to be understood that the disclosure is not to be limited to the specific embodiments disclosed and that modifications and other embodiments are intended to be included within the scope of the appended claims. Although specific terms are employed herein, they are used in a generic and descriptive sense only and not for purposes of limitation.

### VII. Examples

Example 1. A computer-implemented method comprising: receiving, by one or more processors and from a user device, a remote document verification request indicating a subject document to be verified; transmitting, by the one or more processors and to the user device, an interface configured to receive user input corresponding to the subject document; receiving, by the one or more processors and via the transmitted interface, the user input corresponding to the subject document; generating, by the one or more processors and based on the subject document and the user input, an updated document; creating, by the one or more processors and via a printer device, a physical document corresponding to the updated document; providing, by the one or more processors and to the user device, a media feed displaying the physical document as it is created; and causing transmission, by the one or more processors and to the user device, of a prompt to be displayed to the user via which the user can indicate verification of the physical document.

Example 2. The computer-implemented method of any of the preceding examples, wherein the media feed displaying the physical document corresponds to a video feed from a camera positioned to display an output feed of the printer device.

Example 3. The computer-implemented method of any of the preceding examples further comprising: transmitting, by the one or more processors, an identification verification request to a personal device corresponding to the user; and receiving, by the one or more processors, a verification indication from the personal device.

Example 4. The computer-implemented method of any of the preceding examples, wherein the physical document includes an identifying mark corresponding to the user.

Example 5. The computer-implemented method of any of the preceding examples, wherein the subject document is a voting ballot.

Example 6. The computer-implemented method of example 5, wherein the media feed additionally displays insertion of the subject document into a ballot box.

Example 7. The computer-implemented method of any of the preceding examples, wherein the media feed additionally includes an audio clip including a screen reading of one or more text portions of the physical document.

Example 8. The computer-implemented method of any of the preceding examples, wherein receiving the user input corresponding to the subject document comprises receiving one or more sections of the user input one section at a time.

Example 9. The computer-implemented method of example 8, wherein creating the physical document corresponding to the updated document comprises printing the physical document one section at a time.

Example 10. The computer-implemented method of example 9, wherein a subject received section of the one or more sections is printed (i) responsive to receiving the subject received section, and (ii) before a next section of the one or more sections is received.

Example 11. A computing apparatus comprising memory and one or more processors communicatively coupled to the memory, the one or more processors configured to: receive, by one or more processors and from a user device, a remote document verification request indicating a subject document to be verified; transmit, by the one or more processors and to the user device, an interface configured to receive user input corresponding to the subject document; receive, by the one or more processors and via the transmitted interface, the user input corresponding to the subject document; generate, by the one or more processors and based on the subject document and the user input, an updated document; create, by the one or more processors and via a connected printer device, a physical document corresponding to the updated document; provide, by the one or more processors and to the user device, a media feed displaying the physical document as it is created; and cause transmission, by the one or more processors and to the user device, of a prompt to be displayed to the user via which the user can indicate verification of the physical document.

Example 12. The computing apparatus of any of the preceding examples, wherein the media feed displaying the physical document corresponds to a video feed from a camera positioned to display an output feed of the printer device.

Example 13. The computing apparatus of any of the preceding examples, wherein the physical document includes an identifying mark corresponding to the user.

Example 14. The computing apparatus of any of the preceding examples, wherein the one or more processors are further configured to: transmit an identification verification request to a personal device corresponding to the user; and receive a verification indication from the personal device.

Example 15. The computing apparatus of any of the preceding examples, wherein the media feed additionally comprises an audio clip including a screen reading of one or more text portions of the physical document.

Example 16. One or more non-transitory computer-readable storage media including instructions that, when executed by one or more processors, cause the one or more processors to: receive, by one or more processors and from a user device, a remote document verification request indicating a subject document to be verified; transmit, by the one or more processors and to the user device, an interface configured to receive user input corresponding to the subject document; receive, by the one or more processors and via the transmitted interface, the user input corresponding to the subject document; generate, by the one or more processors and based on the subject document and the user input, an updated document; create, by the one or more processors and via a connected printer device, a physical document corresponding to the updated document; provide, by the one or more processors and to the user device, a media feed displaying the physical document as it is created; and cause transmission, by the one or more processors and to the user device, of a prompt to be displayed to the user via which the user can indicate verification of the physical document.

Example 17. The computer program product of any of the preceding examples further comprising instructions that cause the computing apparatus to: monitor one or more agent interactions associated with the performance of the one or more prediction-based actions; and generate the training agent interaction data based on the monitored one or more agent interactions.

Example 18. The one or more non-transitory computer-readable storage media of any of the preceding examples, wherein the instructions further cause the one or more processors to: transmit an identification verification request to a personal device corresponding to the user; and receive a verification indication from the personal device.

Example 19. The one or more non-transitory computer-readable storage media of any of the preceding examples, wherein the physical document includes an identifying mark corresponding to the user.

Example 20. The one or more non-transitory computer-readable storage media of any of the preceding examples, wherein the media feed displaying the physical document corresponds to a video feed from a camera positioned to display an output feed of the printer device.

1. A computer-implemented method comprising:
receiving, by one or more processors and from a user device, a remote document verification request indicating a subject document to be verified;
transmitting, by the one or more processors and to the user device, an interface configured to receive user input corresponding to the subject document;
receiving, by the one or more processors and via the transmitted interface, the user input corresponding to the subject document;
generating, by the one or more processors and based on the subject document and the user input, an updated document;
creating, by the one or more processors and via a printer device, a physical document corresponding to the updated document;
providing, by the one or more processors and to the user device, a media feed displaying the physical document as it is created; and
causing transmission, by the one or more processors and to the user device, of a prompt to be displayed to the user device via which a user of the user device can indicate verification of the physical document.

2. The computer-implemented method of claim 1, wherein the media feed displaying the physical document corresponds to a video feed from a camera positioned to display an output feed of the printer device.

3. The computer-implemented method of claim 1 further comprising:
transmitting, by the one or more processors, an identification verification request to a personal device corresponding to the user; and
receiving, by the one or more processors, a verification indication from the personal device.

4. The computer-implemented method of claim 1, wherein the physical document includes an identifying mark corresponding to the user.

5. The computer-implemented method of claim 1, wherein the subject document is a voting ballot.

6. The computer-implemented method of claim 5, wherein the media feed additionally displays insertion of the subject document into a ballot box.

7. The computer-implemented method of claim 1, wherein the media feed additionally includes an audio clip including a screen reading of one or more text portions of the physical document.

8. The computer-implemented method of claim 1, wherein receiving the user input corresponding to the subject document comprises receiving one or more sections of the user input one section at a time.

9. The computer-implemented method of claim 8, wherein creating the physical document corresponding to the updated document comprises printing the physical document one section at a time.

10. The computer-implemented method of claim 9, wherein a subject received section of the one or more sections is printed (i) responsive to receiving the subject received section, and (ii) before a next section of the one or more sections is received.

11. A computing apparatus comprising memory and one or more processors communicatively coupled to the memory, the one or more processors configured to:
receive, from a user device, a remote document verification request indicating a subject document to be verified;
transmit, to the user device, an interface configured to receive user input corresponding to the subject document;
receive, via the transmitted interface, the user input corresponding to the subject document;
generate, based on the subject document and the user input, an updated document;
create, via a printer device, a physical document corresponding to the updated document;
provide, to the user device, a media feed displaying the physical document as it is created; and
cause transmission, to the user device, of a prompt to be displayed to the user device via which a user of the user device can indicate verification of the physical document.

12. The computing apparatus of claim 11, wherein the media feed displaying the physical document corresponds to a video feed from a camera positioned to display an output feed of the printer device.

13. The computing apparatus of claim 11, wherein the physical document includes an identifying mark corresponding to the user.

14. The computing apparatus of claim 11, wherein the one or more processors are further configured to:
transmit an identification verification request to a personal device corresponding to the user; and
receive a verification indication from the personal device.

15. The computing apparatus of claim 11, wherein the media feed additionally comprises an audio clip including a screen reading of one or more text portions of the physical document.

16. One or more non-transitory computer-readable storage media including instructions that, when executed by one or more processors, cause the one or more processors to:
receive, from a user device, a remote document verification request indicating a subject document to be verified;
transmit, to the user device, an interface configured to receive user input corresponding to the subject document;
receive, via the transmitted interface, the user input corresponding to the subject document;
generate, based on the subject document and the user input, an updated document;
create, via a printer device, a physical document corresponding to the updated document;
provide, to the user device, a media feed displaying the physical document as it is created; and
cause transmission, to the user device, of a prompt to be displayed to the user device via which a user of the user device can indicate verification of the physical document.

17. The one or more non-transitory computer-readable storage media of claim 16, wherein the media feed displaying the physical document corresponds to a video feed from a camera positioned to display an output feed of the printer device.

18. The one or more non-transitory computer-readable storage media of claim 16, wherein the instructions further cause the one or more processors to:
transmit an identification verification request to a personal device corresponding to the user; and
receive a verification indication from the personal device.

19. The one or more non-transitory computer-readable storage media of claim 16, wherein the physical document includes an identifying mark corresponding to the user.

20. The one or more non-transitory computer-readable storage media of claim 16, wherein the media feed displaying the physical document corresponds to a video feed from a camera positioned to display an output feed of the printer device.
